(19) United States
(12) Patent Application Publication
(10) Pub. No.: US 2014/0280977 A1
(43) Pub. Date: Sep. 18, 2014

(54) SYSTEMS AND METHODS FOR EVALUATING COMPUTING RESOURCES

(71) Applicant: ServiceMesh, Inc., Santa Monica, CA (US)

(72) Inventors: Frank Martinez, La Canada, CA (US); Eric Pulier, Santa Monica, CA (US); David Roberts, Austin, TX (US)

(73) Assignee: ServiceMesh, Inc., Santa Monica, CA (US)

(21) Appl. No.: 14/213,411

(22) Filed: Mar. 14, 2014

Related U.S. Application Data
(60) Provisional application No. 61/801,199, filed on Mar. 15, 2013.

(51) Int. Cl. H04L 12/911

(52) U.S. Cl. CPC H04L 47/822
USPC 709/226

(57) ABSTRACT

Systems, methods, and non-transitory computer-readable media can receive information about requested resources from a computational resource consumer. The information about the requested resources can be analyzed to generate a first multi-dimensional array including a first set of name-value pairs associated with the requested resources. Information about offered resources can be received from a computational resource provider. The information about the offered resources can be analyzed to generate a second multi-dimensional array including a second set of name-value pairs associated with the offered resources. The first multi-dimensional array and the second multi-dimensional array can be evaluated based on an evaluation algorithm.

### CROSS-REFERENCE TO RELATED APPLICATION

This application claims priority to U.S. Provisional Application No. 61/801,199, filed on Mar. 15, 2013 and titled “SYSTEM AND METHOD FOR CLOUD COMPUTING WITH METASCHEDULER”, which is incorporated by reference herein in its entirety.

### FIELD OF THE INVENTION

The present technology relates to the field of computing resources. More particularly, the present technology relates to systems and techniques for evaluating computing resources.

### BACKGROUND

The use of network environment services, such as cloud computing services, is increasing. Users can utilize cloud computing services to provide infrastructure, platforms, and other services. In one example, entities such as corporations can utilize cloud computing to provide applications or services. In another example, application developers can utilize cloud environments to deploy applications (or services). In some cases, users may desire to compare different cloud computing services, such as for the purpose of determining which cloud computing service is better suited to handle the users' computational needs. In some instances, users may desire to evaluate the resource requirements needed for various applications. However, under conventional approaches, it can be difficult to evaluate or compare computing resources.

In one example, a user may desire to run an application, program, or other workload via cloud computing. In this example, there can be a multitude of cloud computing services available to the user, each service having its own respective resources and associated resource metrics (e.g., performance metrics, capabilities, properties, costs). Under conventional approaches, it can be difficult, inconvenient, or inefficient to evaluate and compare the multitude of available cloud computing services to determine which cloud computing service best suits the needs of the user. These and other concerns can create challenges for and reduce the overall experience associated with evaluating computing resources (and related metrics), such as those associated with cloud computing infrastructures, units of consumption, services, and/or applications.

### SUMMARY

Various embodiments of the present disclosure can include systems, methods, and non-transitory computer readable media configured to receive information about requested resources from a computational resource consumer. The information about the requested resources can be analyzed to generate a first multi-dimensional array including a first set of name-value pairs associated with the requested resources. Information about offered resources can be received from a computational resource provider. The information about the offered resources can be analyzed to generate a second multi-dimensional array including a second set of name-value pairs associated with the offered resources. The first multi-dimensional array and the second multi-dimensional array can be evaluated based on an evaluation algorithm.

In one embodiment, it can be determined, based on evaluating the first multi-dimensional array and the second multi-dimensional array, that the offered resources match the requested resources within an allowable deviation.

In one embodiment, the evaluation algorithm can be configured to compare at least a subset of the first set of name-value pairs and at least a subset of the second set of name-value pairs.

In one embodiment, the name-value pairs in the first set and the name-value pairs in the second set can each be associated with one computing attribute out of a plurality of computing attributes. The plurality of computing attributes can include at least one of a CPU attribute, a memory attribute, a hard disk attribute, a network speed attribute, a latency attribute, an encryption attribute, a bandwidth attribute, a utilization attribute, a capacity attribute, or a user-defined attribute.

In one embodiment, at least one computing attribute from the plurality of computing attributes can be associated with a weight value.

In one embodiment, the requested resources can be associated with a computing workload, and the offered resources can be associated with at least one of a computing unit of consumption or a computing infrastructure.

In one embodiment, a marketplace, configured to facilitate one or more interactions between the computational resource consumer and the computational resource provider, can be provided.

In one embodiment, a computing system can be associated with an abstraction layer. The abstraction layer can be configured to facilitate one or more interactions associated with the requested resources from the computational resource consumer and with the offered resources from the computational resource provider.

Many other features and embodiments of the disclosed technology will be apparent from the accompanying drawings and from the following detailed description.

### BRIEF DESCRIPTION OF THE DRAWINGS

FIG. 1 illustrates an example graphical representation of requested resource metrics and offered resource metrics, according to an embodiment of the present disclosure.

FIG. 2 illustrates an example graphical representation of requested resource metrics of multiple workloads and offered resource metrics, according to an embodiment of the present disclosure.

FIG. 3 illustrates an example graphical representation of requested partially non-consumable resource metrics of multiple workloads and offered resource metrics, according to an embodiment of the present disclosure.

FIG. 4 illustrates an example graphical representation of requested partially oversubscribed resource metrics of multiple workloads and offered resource metrics, according to an embodiment of the present disclosure.

FIG. 5 illustrates an example graphical representation of requested resource metrics of multiple workloads, offered resource metrics, and wastage incurred in the offered resource metrics, according to an embodiment of the present disclosure.

FIG. 6A illustrates an example method for providing resource requirements of a workload in a multi-dimensional array format, according to an embodiment of the present disclosure.

FIG. 6B illustrates an example method for providing resource requirements of a unit of consumption in a multi-dimensional array format, according to an embodiment of the present disclosure.

FIG. 6C illustrates an example method for providing resource requirements of an infrastructure in a multi-dimensional array format, according to an embodiment of the present disclosure.

FIG. 6D illustrates an example method for evaluating computing resources, according to an embodiment of the present disclosure.

FIG. 6E illustrates an example system configured to evaluate computing resources, according to an embodiment of the present disclosure.

FIG. 7 shows a diagram illustrating an example system in accordance with an embodiment of the present disclosure.

FIG. 8 shows a diagram illustrating an example management module in accordance with an embodiment of the present disclosure.

FIG. 9 illustrates an example of a computing device or system that can be used to implement one or more of the embodiments described herein, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Evaluating Computing Resources

It is becoming more commonplace to analogize and describe cloud computing as being similar to “electrical grids for computing capacity,” where consumers can purchase computational capabilities on demand from a computing utility. While this analogy is not entirely accurate, it is a reasonable approximation and can help some people envision how cloud computing might work.

Many have begun to ask the question, “If cloud computing is similar to the electrical utility model, then what is the cloud computing equivalent to the kilowatt-hour (kWh)?” If such a unit existed, then it can potentially be used to measure cloud consumption and generate appropriate invoices. Further, the unit (if it existed) could potentially be used to rate the capacity/capabilities of a given cloud infrastructure, similar to how megawatts (MWs) can be used to rate the capacity of electrical power plants.

Unfortunately, cloud computing is not as simple as raw electricity. Running a program on a modern computer can involve the consumption of multiple connected resources. These resources can include (but are not limited to) the Central Processing Unit (CPU) (e.g., comprising Arithmetic Logic Units (ALUs), registers, cache, memories, etc.), the main memory (e.g., Random Access Memory (RAM)) which usually holds the program and working data involved with computational tasks, and the persistent storage (e.g., hard disk drives (HDDs)) that holds program state information, which in some cases must be stored during system restarts.

Therefore, with respect to a computing environment having multiple resources, attempting to create a fundamental resource consumption unit to measure cloud computing, in an analogous manner as to kWh in the electrical grid environment, can be problematic. The kWh unit can correspond to a scalar unit, whereas computational needs should be described in a multi-dimensional fashion. For instance, in order to perform a computation, a certain amount of GHz of CPU cycles can be required to perform the computation in a reasonable time and a certain quantity of MB of RAM can be required as well. In this example, the computational needs can be described in two dimensions (e.g., CPU cycles and RAM). Often times, other resources (and thus additional dimensions) can also be required. However, CPU cycles and RAM are fundamentally different, non-interchangeable resources. For example, if a given application requires 3 GHz of CPU cycles and 1024 MB of RAM, the application cannot be expected to run in an equivalent fashion using 1024 GHz of CPU cycles and 3 MB of RAM. As such, attempting to create a scalar unit to measure computing can be flawed.

In some cases, a slightly more appropriate analogy can correspond to comparing cloud computing with electricity and natural gas. For example, a given appliance (e.g., stove) in a household can use either electricity or gas. If the stove is an electric stove, then the electric stove only works when electricity is provided to it. Similarly, if the stove is a gas stove, then the gas stove only works when gas is provided to it. Electricity can be measured in kWh, while gas can often be measured in therms or British Thermal Units (BTUs). Often times, running various household appliances can require both resources. Electric appliances can require electricity only (and are not configured to operate using gas), while gas appliances can require gas only (and are not configured to operate using electricity). Moreover, household demand for electrical and household demand for gas cannot be readily converted. As such, in some cases, when utility companies perform capacity planning, they have to plan to deliver both electricity and gas to each house, and they need to understand the consumption trends for each of these resources, independent of the other.

Nonetheless, analogizing cloud computing to electricity/gas is still flawed because both electricity and gas can be used to convey energy and can ultimately be used to perform similar tasks. In some cases, natural gas can even be used to generate electricity. However, that is not necessarily true with computing resources and metrics, such as CPU cycles and RAM. There is no way to convert CPU cycles to RAM, or RAM to CPU cycles. This further establishes that computing resources/requirements (which can be described with resource metrics) are multi-dimensional, such that attempting to create a scalar unit to measure computing (e.g., cloud computing) is problematic.

Various embodiments of the present disclosure can provide an improved format to describe cloud computing requirements and/or resources (and related metrics). The improved format can allow for more suitable descriptions of computing workloads, computing Stock Keeping Units (SKUs) (i.e., units of consumption), and/or computing infrastructures. Various embodiments of the present disclosure can provide an approach for evaluating computing resources (and metrics), such as a process for comparing different cloud offerings to determine how well the cloud offerings meet the demands of a given workload.

In some embodiments, the disclosed technology can enable the computing resource requirements of a given workload to be expressed. This can allow for a determination (or estimation) of whether or not the given workload can run on a particular infrastructure. This can also allow for the calculation (or approximation) of costs that can be associated with running the given workload on the particular infrastructure for a period of time.

Moreover, in some implementations, the disclosed technology can enable the capacity/capabilities of given cloud-computing Stock Keeping Units (SKUs) to be expressed. For instance, certain cloud providers have a number of instance “sizes,” which can also offer different capabilities. Embodiments of the present disclosure can compare workloads with SKUs to determine whether or not the workloads can “fit” within the resources provided by the SKUs. In other words, embodiments of the present disclosure can facilitate determining whether or not the SKUs can sufficiently provide the computing or other resources required by the workloads. In addition, the present disclosure can allow for comparison between the SKUs of one provider and the SKUs of another provider. In one example, if the least costly SKU capable of accommodating a given workload can be determined out of a plurality of SKUs offered by multiple cloud service providers, then cost comparisons can also be performed to determine which service provider is the most cost effective for the given workload.

In some embodiments, the disclosed technology can allow for the capacity(ies) and capability(ies) of a given infrastructure to be expressed. Similar to how a power plant can be expressed or described as being an X-megawatt power plant, embodiments of the present disclosure can enable computing infrastructures to be adequately described.

Furthermore, in some implementations, the disclosed technology can utilize one or more evaluation algorithms to conduct comparisons among workloads, SKUs, and/or infrastructures. For example, algebraic formulas can be used to provide a set of rules expressing how to manipulate multiple descriptions (or computing resource metrics) in combination. In some cases, the evaluation algorithm(s) can set forth the relationships among various computing resource metrics (e.g., the importance of CPU cycles to a given workload relative to the importance of RAM to the given workload).

Various embodiments can provide a format for a multi-dimensional descriptor useful for describing computing resources and associated metrics (i.e., metrics for measuring the capacities, capabilities, performance, etc., of requested resources and/or offered resources). In some cases, the format can be referred to as a Computational Resource Attribute Tuple, Extensible (CRATE). In some instances, CRATE can correspond to a format, rather than a unit of measure. For example, a computing resource can be described in terms of CRATE “dimensions,” rather than a number of CRATEs.

The CRATE format can correspond to the following: (r1name [=value1 [unit1]], r2name [=value2 [unit2]], r3name [=value3 [unit3]], . . . ). The variable r1name can correspond to the name of a first resource. The variable value1 can correspond to the value of the first resource. The variable unit1 can correspond to the unit of measurement for the value of the first resource. Similarly, r2name can be the name of a second resource, value2 can be the value of the second resource, and unit2 can be the unit of measurement for the value of the second resource. Likewise, a third resource can be characterized by r3name, value3, and unit3, and so forth. Accordingly, the CRATE format can correspond to a multi-dimensional array of elements, wherein each element can correspond to a name-value pair.

In some instances, certain resources can include scalar values to be specified with magnitudes. In a first example, a resource (e.g., requested resource, offered resource) can have a CRATE format corresponding to: (CPU=3 GHz, RAM=2048 MB, HDD=30 GB, Network=1 Gbps). In a second example, a resource can have a CRATE format that corresponds to: (CPU=2.4 GHz, Network=100 Mbps, HDD=10 GB, RAM=4 GB, Max-latency[example.foo.com]=50 ms, Network-encryption={aes256-cbc, aes512-cbc, 3des-cbc}). In the two previous examples, the format is both readable for humans as well as machine-parsable (i.e., capable of being analyzed or read by a machine). If the resource is a requested resource (e.g., requested by a consumer), then its CRATE format can specify the needs of an application, service, and/or workload of the consumer. If the resource is an offered resource (e.g., offered by a provider), then its CRATE format can specify the capabilities of an SKU and/or infrastructure offered by the provider. Moreover, the second example illustrates how the CRATE format can be extensible beyond fixed CPU, memory, mass storage, and network attributes. In the second example, it can be expressed that wherever the computation runs, the network latency between it and a given network address (expressed as a DNS name, e.g., example.foo.com) should be less than the specified duration (e.g., 50 ms). Further, in the second example, the network link can be encrypted with one of the specified encryptions (which can specified in an order of preference).

With reference now to FIG. 1, an example graphical representation 100 of requested resource metrics and offered resource metrics is illustrated, according to an embodiment of the present disclosure. As discussed above, various embodiments of the present disclosure can enable comparison of SKUs between various clouds/providers. In FIG. 1, the example graphical representation 100 can illustrate a vertical axis 110 representing a first CRATE dimension or CRATE Dimension A (e.g., CPU), and a horizontal axis 120 representing a second CRATE dimension or CRATE Dimension B (e.g., RAM). Moreover, resource metrics 130 for a requested resource, resource metrics 140 for a first offered resource, and resource metrics 150 for a second offered resource can be illustrated in the example graphical representation 100. In one example, a first offered SKU (represented by resource metrics 140) can be described in CRATE format as: (CPU=2.4 GHz, RAM=512 MB). A second offered SKU (represented by resource metrics 150) can be described in CRATE format as: (CPU=1.5 GHz, RAM=1024 MB). Further, a workload having requested resource metrics 130 can have the following CRATE: (CPU=1.2 GHz, RAM=768 MB).

One approach to comparing the first and second offered SKUs can utilize a shipping box analogy. In one example scenario, there can be two boxes for shipping items, one optimized for shipping axe handles and the other for shipping basketballs. The axe handle shipping box is long and narrow. The basketball shipping box is a perfect cube, optimized for shipping a sphere. The axe handle shipping box can have dimensions of 3 in.*3 in.*36 in, with an internal volume of 324 cubic inches. The basketball shipping box can have dimensions of 10 in.*10 in.*10 in, with an internal volume of 1000 cubic inches. While the basketball shipping box is larger than the axe handle shipping box in terms of volume, it can be problematic (if not impossible) for the axe handle to completely fit into the basketball shipping box. The issue in this example scenario is that dimensions of shipping boxes are not interchangeable or convertible. In order to fit the axe handle, a shipping box with dimensions of at least 3 in.*3 in.*36 in. is needed.

With regard to computing (e.g., cloud computing), CRATEs can be compared in a similar manner. For example, CPU cycles cannot be readily convertible to RAM memory size, and vice versa. As such, instead of being concerned with which CRATE is “largest,” it can be more meaningful to consider which SKU has the most suitable CRATE dimensions for a given application or workload.

Moreover, cost can be an important factor. Continuing with the shipping box analogy, a single golf-ball can be shipped in a basketball shipping box, but it can be more expensive than necessary to do so. Even though a golf ball can fit and be shipped in a basketball shipping box, doing so can be wasteful, costly, and/or inefficient. As such, in order to run a given workload (or application, service, etc.), a CRATE having bounding dimensions that at least meet (or exceed) the workload requirement dimensions should be used.

Continuing with the example of FIG. 1, the workload associated with requested resource metrics 130 can fit within the CRATE dimensions of the second offered SKU (represented by resource metrics 150), but not within the CRATE dimensions of the first offered SKU (represented by resource metrics 140). It should be understood that the CRATE for the first offered SKU (represented by resource metrics 140) cannot be “rotated” 90 degrees to fit the workload, because the CRATE dimensions are not readily convertible. In addition, it should be appreciated that even though the graphical representation 100 illustrates two-dimensional CRATEs, there can be additional CRATE dimensions (and computing resource metrics).

As discussed previously, in some embodiments, the disclosed technology can enable comparison of multiple clouds (e.g., cloud infrastructures). For example, if two different cloud providers offered two different clouds, embodiments of the present disclosure can enable the clouds to be compared. In contrast to the field of electricity (in which different electrical power plants can be compared to one another using scalar values/units, e.g., dollars/Watt), different clouds should be compared along multiple dimensions. Accordingly, CRATEs can be used to describe a cloud based on a vector value (e.g., a multi-dimensional array of elements of any number of dimensions), instead of a scalar value. In one example, Cloud A can have a CRATE corresponding to: (CPU=1200 GHz, HDD=4000 GB, Network=1000 Gbps), and Cloud B can have CRATE dimensions of: (CPU=2000 GHz, HDD=8000 GB, Network=500 Gbps).

In some instances, it can be more meaningful to determine which cloud can run the most number of a given set of workloads for the least cost. Running the most number of workloads for the least cost can depend, at least in part, on how efficiently a cloud can pack the workloads. There can be various approaches to efficiently packing workloads. FIG. 2 illustrates an example graphical representation 200 of requested resource metrics of multiple workloads and offered resource metrics, according to an embodiment of the present disclosure. The example graphical representation 200 illustrates a vertical axis 210 representing CRATE Dimension A and a horizontal axis 220 representing CRATE Dimension B. The example graphical representation 200 also illustrates a set of workloads (e.g., workload 230, workload 232, workload 234, workload 236) represented by respective resource metrics (e.g., requested resource metrics). Given the set of workloads, a bounding CRATE 240 (associated with offered resource metrics) can be determined based on how the workloads are packed together.

In some cases, resources (or resource dimensions) are consumable, which means that once allocated to a given workload, a consumable resource (or resource dimension) cannot be used for another workload. For instance, a workload can use a given amount of RAM, and once this RAM is filled with data from the workload, the RAM cannot be used for another workload until the former workload is stopped and the RAM is released. In the example of FIG. 2, both CRATE Dimension A and CRATE Dimension B can be consumable. As such, the CRATES for the workloads can be “stacked” or packed in a corner-to-corner manner, as shown. The dimensions of the bounding CRATE 240 can be constructed as the total sum of each of the workload dimensions.

It should also be appreciated that many cloud computing resources (or resource dimensions) are not necessarily consumable. For instance, in some cases, latency is not consumable. A cloud can either be capable of delivering the appropriate latency required (or requested), or not. The act of placing, on a cloud, one workload that requires a given latency generally does not affect the latency of other workloads placed on the cloud (assuming that the cloud has been well-engineered to avoid overloading particular network or other resource chokepoints). FIG. 3 shows an example of how CRATEs can be packed together for a non-consumable resource dimension. When a resource dimension is non-consumable, the maximum (or minimum in some cases) of the workload CRATEs in that dimension can be taken into consideration.

FIG. 3 illustrates an example graphical representation 300 of requested partially non-consumable resource metrics of multiple workloads and offered resource metrics, according to an embodiment of the present disclosure. The example graphical representation 300 illustrates a vertical axis 310 representing CRATE Dimension A and a horizontal axis 320 representing CRATE Dimension B. The example graphical representation 300 also illustrates a set of workloads (e.g., workload 330, workload 332, workload 334, workload 336) represented by respective resource metrics (e.g., requested resource metrics). In this example, CRATE Dimension A can be consumable but CRATE Dimension B can be non-consumable. As such, the CRATEs for the set of workloads can be packed to fully overlap with respect to CRATE Dimension B. A bounding CRATE 340 (associated with offered resource metrics) can also be established for the set of workloads.

Furthermore, even when resource dimensions are consumable, oversubscription can be utilized. Oversubscription can refer to the concept of allowing more workloads to be run in a given bounding CRATE. Oversubscription can be analogized to making a statistical gamble that not all of the workloads will actually need all of the resources at the same time. If the gamble pays off, then more workloads will be running and the oversubscription has made better use of the infrastructure. If the gamble does not pay off, then that can result in resource contention, which can lead to decreased performance, errors, and/or aborted processing. A good example of a resource dimension worth oversubscribing to can include network bandwidth.

FIG. 4 illustrates an example graphical representation 400 of requested partially oversubscribed resource metrics of multiple workloads and offered resource metrics, according to an embodiment of the present disclosure. The example graphical representation 400 illustrates a vertical axis 410 representing CRATE Dimension A and a horizontal axis 420 representing CRATE Dimension B. The example graphical representation 400 also illustrates a set of workloads (e.g., workload 430, workload 432, workload 434, workload 436) represented by respective resource metrics (e.g., requested resource metrics). In this example, the workloads can be oversubscribed with respect to CRATE Dimension B. As such, the CRATEs for the set of workloads can be packed with overlapping areas 450 with respect to CRATE Dimension B. A bounding CRATE 440 (associated with offered resource metrics) can be established for the set of workloads.

Moreover, it should be appreciated that clouds are not generally implemented as infinitely granular pools of resources. Rather, there can be quantization that exists within any given pool. For instance, a cloud with thousands of GHz of total CPU capacity is actually implemented on hundreds of physical cores, CPU sockets, and servers. Barring advanced clustering technology, any given Infrastructure-as-a-Service (IaaS) workload (e.g., Virtual Machine running an OS image) must fit within the constraints of a single server system. This can prevent the perfect packing of workloads into a given cloud and can lead to some wastage whenever another workload cannot be packed into the remaining resource quanta.

FIG. 5 illustrates an example graphical representation 500 of requested resource metrics of multiple workloads, offered resource metrics, and wastage incurred in the offered resource metrics, according to an embodiment of the present disclosure. The example graphical representation 500 illustrates a vertical axis 510 representing CRATE Dimension A and a horizontal axis 520 representing CRATE Dimension B. The example graphical representation 500 also illustrates a set of workloads (e.g., workload 530, workload 532, workload 534, workload 536) represented by respective resource metrics (e.g., requested resource metrics). In this example, there can be wastage 550 due to imperfect packing of the workloads. A bounding CRATE 540 (associated with offered resource metrics) can also be established for the set of workloads. In some instances, more efficient workload packing can reduce wastage. Again, there can be various approaches to achieving efficient workload packing.

Moreover, while some embodiments of CRATEs have been described herein with two-dimensions, a CRATE can have any suitable number of dimensions.

FIG. 6A illustrates an example method 600 for providing resource requirements of a workload in a multi-dimensional array format, according to an embodiment of the present disclosure. It should be appreciated that there can be additional, fewer, or alternative steps performed in similar or alternative orders, or in parallel, within the scope of the various embodiments unless otherwise stated. At step 602, the example method 600 can acquire (or receive, obtain, etc.) information about resource metrics (e.g., resource requirements) requested for a workload. Step 604 can include analyzing (e.g., machine-parsing) the information about the resource metrics requested for the workload.

At step 606, the example method 600 can generate a multi-dimensional array including elements that represent the resource metrics requested for the workload. The multi-dimensional array can correspond to a CRATE, and the elements can correspond to name-value pairs for each CRATE dimension (e.g., computing resource metric). In some implementations, generating the multi-dimensional array can be based on analyzing the information about the resource metrics requested for the workload. Step 608 can include providing access to at least some of the elements included in the multidimensional array.

FIG. 6B illustrates an example method 620 for providing resource requirements of a unit of consumption in a multi-dimensional array format, according to an embodiment of the present disclosure. Again, there can be additional, fewer, or alternative steps performed in similar or alternative orders, or in parallel, within the scope of the various embodiments unless otherwise stated. The example method 620 can acquire (or receive, obtain, etc.) information about resource metrics offered by the unit of consumption (i.e., SKU), at step 622. Step 624 can include analyzing the information about the resource metrics offered by the unit of consumption.

At step 626, the example method 620 can generate a multi-dimensional array (e.g., CRATE) including elements that represent the resource metrics offered by the unit of consumption. Step 628 can include providing access to at least some of the elements included in the multidimensional array.

FIG. 6C illustrates an example method 640 for providing resource requirements of an infrastructure in a multi-dimensional array format, according to an embodiment of the present disclosure. It should be understood that there can be additional, fewer, or alternative steps performed in similar or alternative orders, or in parallel, within the scope of the various embodiments unless otherwise stated. The example method 640 can acquire information about resource metrics offered by the infrastructure (i.e., cloud), at step 642. Step 644 can include analyzing the information about the resource metrics offered by the infrastructure.

At step 646, the example method 640 can generate a multi-dimensional array (e.g., CRATE) including elements that represent the resource metrics offered by the infrastructure. Step 648 can include providing access to at least some of the elements included in the multidimensional array.

FIG. 6D illustrates an example method 660 for evaluating computing resources, according to an embodiment of the present disclosure. As previously discussed, it should be understood that there can be additional, fewer, or alternative steps performed in similar or alternative orders, or in parallel, within the scope of the various embodiments unless otherwise stated. At step 662, the example method 660 can receive information about requested resources from a computational resource consumer (e.g., application/service developer, end-user, cloud computing customer, etc.). Step 664 can include analyzing the information about the requested resources to generate a first multi-dimensional array (e.g., CRATE) including a first set of name-value pairs associated with the requested resources.

The example method 660 can receive information about offered resources from a computational resource provider (e.g., SKU provider, cloud/infrastructure provider), at step 666. The information about the offered resources can be analyzed to generate a second multi-dimensional array (e.g., CRATE) including a second set of name-value pairs associated with the offered resources, at step 668. Step 670 can include evaluating the first multi-dimensional array and the second multi-dimensional array based on an evaluation algorithm.

FIG. 6E illustrates an example system configured to evaluate computing resources, according to an embodiment of the present disclosure. The example system can comprise an evaluation module 680. In some embodiments, the evaluation module 680 can include a resource information receiving module 682, a resource information analyzing module 684, and one or more evaluation algorithms 686. In various embodiments, the evaluation module 680 can implement some or all of the functionality described in connection with FIGS. 1-6D.

In some instances, the resource information receiving module 682 can correspond to an interface, unit, or other component configured to receive (or acquire, obtain, etc.) information about requested resources from a computational resource consumer. The resource information analyzing module 684 can correspond to a component configured to analyze the information about the requested resources to generate a first multi-dimensional array (e.g., CRATE) including a first set of name-value pairs associated with the requested resources.

In some instances, the resource information receiving module 682 can also be configured to receive (or acquire, obtain, etc.) information about offered resources from a computational resource provider. The resource information analyzing module 684 can also be configured to analyze the information about the offered resources to generate a second multi-dimensional array (e.g., CRATE) including a second set of name-value pairs associated with the offered resources. In some cases, the resource information receiving module 682 can comprise two portions, one configured to receive the information about the requested resources and one configured to receive the information about the offered resources. Similarly, in some cases, the resource information analyzing module 684 can comprise two portions, one configured to analyze (and further process) the information about the requested resources and one configured to analyze (and further process) the information about the offered resources.

Furthermore, in some embodiments, the evaluation module 680 can be configured to evaluate the first multi-dimensional array and the second multi-dimensional array based on the one or more evaluation algorithms 686.

In some embodiments, the evaluation module 680 can be implemented, in part or in whole, as a part of a cloud computing platform (e.g., hybrid cloud management platform) and/or as a part of an abstraction layer, which are discussed in more detail below. Moreover, in some embodiments, the evaluation module 680 can be implemented, in part or in whole, in one or more of the various modules included with the cloud computing platform and/or abstraction layer. For example, the evaluation module 680 can be implemented, in part or in whole, in a scheduling module and/or in a manager module of the cloud-computing platform and/or abstraction layer.

Various other embodiments and/or applications are also possible. In one example scenario, one or more embodiments of the present disclosure can allow for the creation of a marketplace or exchange for application workloads and offered services. Consumers can utilize CRATEs to describe their computing needs. Providers can utilize CRATEs to describe their offerings. The marketplace can facilitate the exchange of information and interactions between consumers and providers.

It is further contemplated that there can be many other uses, applications, and/or variations associated with the various embodiments of the present disclosure.

### Abstraction Layer—Example Implementation

FIG. 7 shows a diagram illustrating an example system 710 in accordance with an embodiment of the present disclosure. FIG. 7 illustrates a cloud-computing environment 735 comprising one or more cloud-computing resources, a client network 731 comprising client computing devices 714 (e.g., desktops, laptops, smart mobile devices), and a cloud-computing platform 720 (i.e., cloud management abstraction layer, hybrid cloud management platform) in accordance with an embodiment of the present disclosure. In FIG. 7, cloud-computing platform 720 provides a system through which computing devices 714 residing on client network 731 (e.g., enterprise network) can access one or more cloud-computing services. A cloud-computing service can comprise a cloud-computing resource residing within the cloud-computing environment 735 and managed by the cloud-computing platform 720 to provide the cloud computing service. Depending on the embodiment, cloud-computing environment 735 may comprise one or more cloud providing networks that include cloud-computing resources (e.g., cloud services provided by public or private clouds, which may be external or internal to the enterprise that uses them) that can be utilized by users. Additionally, depending on the embodiment, platform 720 may reside on the client network 731 or separate from the client network 731.

Cloud-computing environment 735 may comprise an internal cloud, an external cloud, a private cloud, or a public cloud (e.g., commercial cloud). In the example of FIG. 7, cloud-computing environment 735 comprises internal private cloud resource 738, external private cloud resource 741, and secure public cloud resource 744. A private cloud may be implemented using a variety of cloud systems including, for example, Eucalyptus Systems, VMWare vSphere®, or Microsoft® HyperV. Providers of public clouds may include, for example, Amazon EC2®, Amazon Web Services®, Terremark®, Savvis®, or GoGrid®. Cloud-computing resources provided by these clouds may include, for example, storage resources (e.g., Storage Area Network (SAN), Network File System (NFS), and Amazon S3®), network resources (e.g., firewall, load-balancer, and proxy server), internal private resources, external private resources, secure public resources, infrastructure-as-a-services (IaaSs), platform-as-a-services (PaaSs), or software-as-a-services (SaaSs).

By using cloud-computing platform 720 to plan, build, manage, or use cloud-computing resources within a cloud-computing environment, users of platform 720 can be provided with standardized access to a variety of cloud-computing resources from disparate cloud-computing systems and providers without concerning themselves with the proprietary details of accessing or interfacing with such cloud-computing systems and providers. The platform 720 can be configured to take the workloads that are developed with the platform 720 and automatically provide the interfaces and access steps necessary to operate the workload on any particular platform or infrastructure element within a federation of cloud computing resources, such that the user is able to interact with the platform 720 to develop such workloads at a level of abstraction that allows the user to configure the logic of the workload (including conditional logic that allows interrelation of different workloads) and to embody the technical, operational, and business requirements of the workload in policies that are associated with the workload, without the user being required to access or understand the details of (or in some cases even know about the existence of) such particular platform or infrastructure elements. Additionally, users of platform 720 can access cloud-computing services through platform 720 on-demand and on a self-service basis through the standardized access. Users of cloud computing services offered by platform 720 may include end users, developers, partners, or administrators that reside on the client network 731.

Platform 720 may comprise planner module 723, manager module 726, builder module 729, and consumption module 732. Planner module 723 can be configured to plan cloud-computing service provided by platform 720 by inventorying, profiling, characterizing and prioritizing computer workloads, such as programs, applets, calculations, applications, servers, or services. For example, with respect to software/application development, planner module 723 may model current applications and associated software-development life cycle (SDLC) phases to determine what infrastructure environments would be required or preferred. This may include defining security, privacy, management or other profiles for each SDLC phase of each application. The profiles, in turn, will identify existing infrastructure and systems that support the SDLC phases, and manage relationships between the infrastructure, systems and the applications. Profiles may also contain characteristics regarding the SDLC phases or attributes relevant to development, deployment or performance of infrastructure, systems, or workloads, such as latency, geography, responsiveness, bandwidth, storage capacity, processing speed, processing type, platforms involved (including operating system, file types, communication protocols, and the like), data involved, protocols used, and specific institutional requirements. In terms of prioritizing the cloud-computing services needed for the SDLC phases, planner 723 may first identify which SDLC computing environments and systems would be suitable for cloud computing or migration to cloud computing, and then prioritize the enablement and operability of newly developed or migrated computer workloads according to the SDLC phases. Subsequently, the characterizations determined by planner module 723 can be used by builder module 729 to build a cloud-computing service or to deploy a computer workload to a cloud-computing resource. In the planner module 723 or in other components of the platform 720 associated with the planner module 23 the user may have access to, or may create or modify, policy information relevant to the computer workloads with which the user can interact in the planner module 723. The policy information may be stored in or associated with a meta model, which may enable the identification, characterization, and storage of a wide range of information, including policy information, that can be associated with a given workload. The metamodel data, including policy information, can be associated with the workload such that throughout the various components of the platform 720, from planning through deployment to a cloud, the workflow can be handled in a manner that is consistent with the metamodel data, and in particular consistent with the policies that are applicable to that workload. In the planner module 723 the planner/user may thus plan the use of workloads in a manner that is consistent with technical, operational, and business requirements that are appropriate with such workload, as seen by association of the same with the workload, and the planner/user may modify or populate the policies associated with the workload, such that the metamodel data for that workload embodies and is consistent with the plans of the planner/user. Once associated with the workload, such policies and other metamodel data are stored by the platform 720 and may be used throughout the development and deployment cycle.

Builder module 729 can be configured to assemble, validate, and publish a cloud-computing service or computer workload for consumption (i.e., use) by a user. Builder module 729 may be configured to receive characterization information from planner module 723 and build a cloud-computing service or computer workload based on the information. For example, builder module 729 may be configured to assemble a cloud computing service based on the prioritized list of computer workloads provided by planner module 723. Builder module 729 may be configured to create and edit scripts for loading computer workloads during installation, startup, runtime, and shutdown of cloud-computing services assembled by builder 729. The scripts for the cloud-computing services may be verified and validated before the cloud-computing services are published for consumption (i.e., use). The script may have access to metamodel and policy information which may alter how the script uses the metamodel and policy information to make a decision. Additionally, builder module 729 may be configured to associate the computer workload with the appropriate cloud-computing service or resource (e.g., associate an application with an appropriate underlying virtual machine image or associate a computer workload with a specific network). As with the planner module 723, in the builder module 729 the user/builder may have access to, or may create or modify, policy information relevant to the computer workloads with which the user can interact in the builder module 729, such as the policy information stored in or associated with the above-referenced meta model, which may enable the identification, characterization, and storage of a wide range of information, including policy information, that can be associated with a given workload. In the builder module 729 the builder/user may thus build of workloads in a manner that is consistent with technical, operational, and business requirements that are appropriate with such workload, as seen by association of the same with the workload, and the builder/user may modify or populate the policies associated with the workload, such that the metamodel data for that workload embodies and is consistent with the plans of the planner/user. In embodiments, the builder module 729 may present options to the builder pre-filtered, such as in pre-populated scripts, filtered drop-down menus, that are dictated by or consistent with the policies and other metamodel data associated with a workload, omitting, blocking or hiding options that are inconsistent with such policies. For example, a workload that stores customer data could omit the option to store a social security number if a data privacy regulation prohibits storing such data in the business process to which the workload relates. Such automatic pre-filtering, pre-configuration, and blocking ensure consistency with the policies associated with the workload at the planning stage (or other stages) while also improving efficiency by removing development paths that might be pursued despite being prohibited. In embodiments, the metamodel provides a flexible structure to organize metadata and apply the same policies using a combination of system and user supplied metadata that may indicate use of the same policy, however may define the same policy in different ways. For example, in some embodiments, the system may consider a Tier 5 datacenter to be the most fault tolerant type of data center and a user may consider a Tier 1 data center to be the most tolerant. The metamodel allows a policy that requires provisioning in the most fault tolerant data center to be assigned Tier 5 or Tier 1 metadata, depending on the definition of the most fault tolerant data center in that specific operating environment.

Eventually, builder module 729 can publish a cloud-computing service for consumption by users. In some embodiments, the builder module 729 can publish the cloud-computing service to a consumption module 732 (e.g., store or storefront such as an application store, a service store, or a software stack store) where users can preview, select, and subscribe to a cloud-computing service for use. Further, in some embodiments, the builder module 729 can enter the cloud-computing service in repository 730 when it is ready and available for consumption by users. Embodiments may also be configured for the builder module 729 such that the development community can approve or disapprove of the cloud-computing service before publication.

Consumption module 732 is configured to allow a user to subscribe to, collaborate on, and assess a cloud-computing service published for consumption. For example, a user can preview cloud-computing services available for deployment to the virtual private cloud and consumption. Then, when a user wants to subscribe and invoke a cloud-computing service for usage, the user can invoke the cloud-computing service on a self-service, on-demand basis through the consumption module 732. Consumption module 732 may list published available cloud-computing service at or near real-time, and allow a user to request updates and information on a listed cloud-computing service. In some embodiments, the consumption module 732 may allow users to collaborate on where, what, and how many cloud-computing services are deployed for consumption. In further embodiments, consumption module 732 may allow a user to comment on and rate cloud-computing services, or assess the cost associated with deploying and using a cloud-computing service. As noted above, as with the planning module 723 and the builder module 729, the consumption module 732 has access to policy information and other metamodel data that is associated with each workload, such that the workload may be consumed only in a manner that is consistent with such policy information. Thus consumption policies related to permitted time, permitted sets of users, security, pricing, resource consumption rules, and a wide variety of other policies may be maintained by the consumption module based on the policies associated with the workload in the platform 720.

Manager module 726 can be configured to provision one or more cloud-computing resources for a cloud-computing service or computer workload, manage one or more cloud-computing resources for the cloud-computing service or computer workload, and monitor one or more cloud-computing resources for the cloud-computing service or computer workload. For example, manager module 726 may provision one or more cloud-computing resources (e.g., provision one or more virtual machine instances) for a published cloud-computing service that is invoked from the consumption module 732. Upon invoking the cloud-computing service, the manager module 726 may deploy and start the one or more cloud-computing resources to the virtual private cloud for the cloud-computing service.

With respect to control, manager module 726 may control the start, stop, or run-time of one or more cloud-computing resources (e.g., control start, stop, or run-time of virtual machine instance) for a cloud-computing service. Manager module 726 may further schedule the start and stop time windows for the one or more cloud-computing resources, or govern a service level, such as per a service level agreement (SLA), or a threshold associated with the one or more cloud-computing resources. Through its control, manager module 726 can govern the cloud-computing resource according to conditions, constraints, security policies, or non-security policies. Manager module 726 may also monitor the one or more cloud-computing resources, detect security intrusions, and monitor the consumption of cloud-computing services their associated cloud-computing resources in order to determine the costs accrued by a user. Aspects of cloud-computing resources monitored by manager module 726 include, for example, central processing unit (CPU) usage, memory usage, data storage usage, data input/output usage, application usage, workload usage, service usage, and other attributes of usage of a service or a computer workload.

In some embodiments, manager module 726 is configured such that a user can request a planner using the planner module 723 to change the design of a cloud-computing service. For example, a user may request that the cloud-computing service change or computer workload with respect to the cloud-computing resources utilized (e.g., change to a platform stack). As in the other components of the platform 720, in the manager module 726 the user may have access to, or may create or modify, policy information or metamodel data relevant to the computer workloads with which the user can interact in the manager module 726. The manager/user of the manager module 726 may thus manage the provisioning of infrastructure and platform elements such that usage will be consistent with the policies of the enterprise, including operational and business policies, as well as technical requirements. For example, provisioning to expensive infrastructure elements may be confined to workloads that satisfy business rules that distinguish between mission critical elements and other elements. The manager/user of the manager module 726 may be provided with access to the policies consistent with the metamodel framework, and in embodiments may be provided with pre-filtered options, such as in menu choices, decision trees, or the like, that are consistent with such policies. For example, a workload designated as non-critical in its metamodel data could automatically appear in the manager module with deployment options confined to relatively low cost clouds, while a mission-critical workload might appear with all different cloud options (or ones that are filtered to satisfy certain requirements as to low latency, bandwidth, storage capacity, guaranteed quality of service, or the like). As with other modules, the manager module 726 may thus enforce policy while streamlining workflow, improving both effectiveness and efficiency.

In some embodiments, the cloud-computing platform can also comprise an evaluation module 750, as shown in FIG. 7. The evaluation module 750 can be configured to facilitate evaluating computing resources. In some implementations, the evaluation module 750 can correspond to the evaluation module 680 of FIG. 6E.

In some cases, the evaluation module 750 can be implemented as software, hardware, or any combination thereof. In some embodiments, the evaluation module 750 can be implemented as a part of the cloud computing platform 720, Moreover, in some embodiments, the evaluation module 750 can be implemented, in part or in whole, in one or more of the various modules included with the cloud-computing platform 720. For example, the evaluation module 750 can be implemented, in part or in whole, in a scheduling module of the cloud-computing platform 720 and/or in the manager module 726 of the cloud-computing platform 720.

FIG. 8 shows a diagram illustrating an example management module 826 (e.g., management module 726 in FIG. 7) in further detail. As illustrated, management module 826 comprises governor module 803 configured to govern operation of a cloud-computing services and its associated cloud-computing resources, provisioning module 806 configured to provision cloud-computing resources for a cloud-computing service, and monitoring module 812 configured to facilitate the various monitoring functions of management module 826.

In embodiments, the present disclosure may provide for a policy-driven infrastructure as a service (IaaS) event bus, which can be comprised of a policy engine, metamodel, reporting system, and workflow engine; and allows for the creation of business policies, such that said business policies can be reflected into a dynamic information technology environment and expressed across internal and external information technology infrastructure, regardless of operating system, programming language, middleware solution, application platform, or cloud provider, by making use of abstraction layers. The workflow engine provides an integration point between the IaaS event bus and workflow management. The abstraction layers allow for integration with application programming interfaces made available by different vendors, business models, technical models, eventing and altering channels and monitoring systems in a vendor agnostic manner. In embodiments the abstraction layer could be a cloud-computing provider. A cloud computing provider may be VMWare, Baremetal, Amazon EC2, Savvis, TerreMark, Microsoft HyperV, and the like. In other embodiments, there may be multiple layers of abstraction in an abstraction layer.

The policy engine allows policies to be created through an easy to use visual interface that allows users that do not necessarily have information technology skills or other programming skills to author and assign policies to workloads. The policies can be expressed via languages such as XML, and the like. In some embodiments of the present disclosure a policy could be an event policy. An event policy supports matching one or more events that are temporally related and generate a notification action when matches occur. An event can be defined as either a threshold condition or matching constraints specified as rules. A rule can be comprised of one or more match constraints and each match constraint must be satisfied, by a logical “and” operation, within a specified sliding time window in order for the notification actions to be invoked. A match specifies the set of conditions that must be satisfied to match an event. Each condition specifies a property of an event or object contained by the event, which is matched against a set of one or more values using the supplied comparison operation If multiple values are supplied for a condition then the result is a logical “or” operation of the property being compared and against each value individually. Any of the event properties or properties of objects contained within the event structure may be used to refine the match criteria. For example, an auto-scaling policy may be created to add more web and database servers according to a ration if a business application becomes heavily loaded, in order to reduce the load on that application. In another example, an auto-scaling policy with business awareness may be created that deploys additional business topologies according to an algorithm if revenue per hour exceeds a threshold.

The metamodel allows the system to abstract business user definition from technical definition and allows an enterprise to track information about information technology resources that were unknown when the system was created. By abstracting the business user definition from the technical definition, the metamodel allows business users to define data classes consistent with their enterprise nomenclature, while still being able to map them consistently to the internal system. For example a Tier 4 data center is common technical classification of a data center that generally has the highest uptime, however some enterprises refer to Tier 4 data centers as Tier 1 and the metamodel would allow Tier 1 and Tier 4 to be used interchangeably, depending on the definition used by a specific enterprise. This provides a benefit to the enterprise by eliminating the need to write specific policies for each instance or the need to customize each abstraction layer for individual instances. By tracking information about IT resources that were unknown when the system was created, the metamodel allows business users to arbitrarily define elements of data to track and create policy after the system was built, also allowing the users to track a specific piece of information that is defined for any resources that are managed by the system. Resources could be networks, storage, servers, workloads, topologies, applications, business units, and the like.

In other further embodiments, the policy-driven infrastructure as a service may also include additional components. Additional components may be reporting, auditing, and federated identify management systems.

In embodiments, the present disclosure may provide for a visual policy editor, which provides an easy-to-use graphical user interface to a feature-rich and extensible policy engine, using a visual programming language and policies, eliminating the need for the user to write complex code to define, assign, and enforce policies. The graphical user interface allows the user to author policies using a visual drag-and-drop interface or an XML editor. The visual programming language functions could be loops, variables, branching, switching, pulling of attributes, code execution within a policy, and the like. For example the visual programming language could access an external pricing engine that contains live pricing information, then make a decision on the next step of the execution process, based on the information it receives from the pricing engine. In some embodiments, policies can be enforced at an object level. Objects could be organizational groups, individual projects, different deployment environments, and the like. Policies could be access control policies, firewall policies, event-based policies and the like. Access control policies could include packages, scripts, and the like. Access control policies could be defined by cloud or other service providers, network attributes, network geographic location, security policies, and the like. Firewall policies may include port and network ACL lists that are applied as policies and applied at container level to ensure conformance to corporate standards for port opening/closing. Event based policies relate to service level management and could include compound threshold rules that trigger an action, lifecycle event management, compound event sequences, signature detection, and policy stacking, and the like. For example, a policy could be defined to restrict deployment of a computing workload to private internal clouds in a specific country.

In embodiments, the present disclosure may provide for automated processes to support a continuous integration cycle to migrate a computing workload from a development environment to an operational environment. The continuous integration cycle may include maintaining a code repository, automating the build process, self-testing the build process, automatically deploying the build, and the like. The policies and metamodels defined and assigned to the computing workload environment follow the build from its creation using the Builder Module through to its publication into the Consumption module. This capability allows the enterprise to greatly reduce the time required to develop, test, deploy and update a computing workload. Continuous integration may also include ensuring the modernization, patch management, conforming configuration of deployed cloud-computing services. The embodiments may provide this service as DevToOps policy allowing centrally defined service definition that deployed cloud-compute services can compare against and either update themselves when their configuration no longer matches, warn administrators of non-conformance, rewrite themselves back to conformance when configurations of the cloud-compute services are made arbitrarily, and the like.

As noted before, various embodiments of the present disclosure provide standardized access, management, or control to different types of cloud-computing resources on a self-service, on-demand basis without the user needing to know the specific instructions or details for accessing, managing, or controlling those different target cloud-computing resources.

In some implementations, in order to translate a standard management action for a cloud-computing service to instructions for its cloud-computing resource and/or instructions for a computer workload to be executed on a cloud-computing resource, some management modules may comprise a cloud model data store 809 that maps the management action to the appropriate cloud-computing resources. Subsequently, the management action can be translated to one or more instructions for a target cloud-computing resource and/or a computer workload operating thereon. For example, a topology is an example of a cloud service, where a topology can be comprised of a number of individual virtual machines orchestrated together. A common management action to perform on a topology is to start it. This simple topology start action within the management layer gets turned into a number of individual instructions that get passed down into the cloud service bus 815, such as (1) calculate the Start Up order for topology, (2) initiate ordered startup one VM at a time, (3) as VM's come up, attach volumes that are associated with the VM, (4) install any packages and software onto the VM's, and (5) once all machines are up and running the topology status changes to running.

Cloud service bus 815 may be utilized to parse management instructions received from the manager module 826, transform the management instructions to instructions compatible with the target cloud-computing resource, and route the management instruction to the targeted cloud-computing resource. In some embodiments, the cloud service bus 815 can then route, via a connection module(s) 818, the instructions to the application program interface (API) 821 for a target cloud-computing resource from an external commercial cloud resource(s) 827, or to the virtual machine manager (VMM) (e.g., hypervisor) 824 for a target cloud-computing resource from an internal private cloud resource(s) 830.

### Hardware Implementation

The foregoing processes and features can be implemented by a wide variety of machine and computer system architectures and in a wide variety of network and computing environments. FIG. 9 illustrates an example of a computer system 900 that may be used to implement one or more of the embodiments described herein in accordance with an embodiment of the invention. The computer system 900 includes sets of instructions for causing the computer system 900 to perform the processes and features discussed herein. The computer system 900 may be connected (e.g., networked) to other machines. In a networked deployment, the computer system 900 may operate in the capacity of a server machine or a client machine in a client-server network environment, or as a peer machine in a peer-to-peer (or distributed) network environment. In an embodiment of the invention, the computer system 900 may be a component of the networking system described herein. In an embodiment of the present disclosure, the computer system 900 may be one server among many that constitutes all or part of a networking system.

The computer system 900 can include a processor 902, a cache 904, and one or more executable modules and drivers, stored on a computer-readable medium, directed to the processes and features described herein. Additionally, the computer system 900 may include a high performance input/output (I/O) bus 906 or a standard I/O bus 908. A host bridge 910 couples processor 902 to high performance I/O bus 906, whereas I/O bus bridge 912 couples the two buses 906 and 908 to each other. A system memory 914 and one or more network interfaces 916 couple to high performance I/O bus 906. The computer system 900 may further include video memory and a display device coupled to the video memory (not shown). Mass storage 918 and I/O ports 920 couple to the standard I/O bus 908. The computer system 900 may optionally include a keyboard and pointing device, a display device, or other input/output devices (not shown) coupled to the standard I/O bus 908. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 900, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 900 are described in greater detail below. In particular, the network interface 916 provides communication between the computer system 900 and any of a wide range of networks, such as an Ethernet (e.g., IEEE 802.3) network, a backplane, etc. The mass storage 918 provides permanent storage for the data and programming instructions to perform the above-described processes and features implemented by the respective computing systems identified above, whereas the system memory 914 (e.g., DRAM) provides temporary storage for the data and programming instructions when executed by the processor 902. The I/O ports 920 may be one or more serial and/or parallel communication ports that provide communication between additional peripheral devices, which may be coupled to the computer system 900.

The computer system 900 may include a variety of system architectures, and various components of the computer system 900 may be rearranged. For example, the cache 904 may be on-chip with processor 902. Alternatively, the cache 904 and the processor 902 may be packed together as a “processor module”, with processor 902 being referred to as the “processor core”. Furthermore, certain embodiments of the invention may neither require nor include all of the above components. For example, peripheral devices coupled to the standard I/O bus 908 may couple to the high performance I/O bus 906. In addition, in some embodiments, only a single bus may exist, with the components of the computer system 900 being coupled to the single bus. Furthermore, the computer system 900 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 900 that, when read and executed by one or more processors, cause the computer system 900 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 900, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 902. Initially, the series of instructions may be stored on a storage device, such as the mass storage 918. However, the series of instructions can be stored on any suitable computer readable storage medium. Furthermore, the series of instructions need not be stored locally, and could be received from a remote storage device, such as a server on a network, via the network interface 916. The instructions are copied from the storage device, such as the mass storage 918, into the system memory 914 and then accessed and executed by the processor 902. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 900 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

It should also be appreciated that the specification and drawings are to be regarded in an illustrative sense. It can be evident that various changes, alterations, and modifications can be made thereunto without departing from the broader spirit and scope of the disclosed technology.

Moreover, the language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed

1. A method comprising:
providing a computational resource attribute tuple, extensible (CRATE); and
providing a format associated with the CRATE.

2. The method of claim 1 wherein the format is readable for humans and machine-parsable.

3. The method of claim 1 wherein the format includes fixed CPU.

4. The method of claim 1 wherein the format includes memory.

5. The method of claim 1 wherein the format includes mass storage.

6. The method of claim 1 wherein the format includes network attributes.
